(19) United States
(12) Patent Application Publication
(10) Pub. No.: US 2020/0022377 A1
(43) Pub. Date: Jan. 23, 2020

(54) METHODS OF COATING SNACK FOOD PRODUCTS

(71) Applicant: FRITO-LAY NORTH AMERICA, INC., Plano, TX (US)

(72) Inventors: Jason BALLENGEE, Lewisville, TX (US); Joseph Donald DONOVAN, Dallas, TX (US); Timothy Allen JOHNSON, Coppell, TX (US); Sathya KALAMBUR, Lewisville, TX (US); Harshal Hemant KSHIRSAGAR, Redwood City, CA (US); Christina Snider MALVAIZ, Little Elm, TX (US); Joyce Jincao XU, Allen, TX (US)

(21) Appl. No.: 16/040,697

(22) Filed: Jul. 20, 2018

(51) Int. Cl. A21D 13/22; A23L 7/13; A23P 20/10; A21D 13/42

(52) U.S. Cl. CPC A21D 13/22; A23L 7/13; A23V 2002/00; A21D 13/42; A23P 20/10

(57) ABSTRACT

An intermediate food base is manufactured from masa that may comprise waxy corn starch. The intermediate food base is then sheeted and dehydrated to between about 15% to about 40% before coating with a solution or batter, and dehydrating to a shelf stable moisture content. The coating solution may be starch-based, fiber-based, or egg white-based. Breading may be added to the coating solution or batter.

### BACKGROUND OF THE INVENTION

### Technical Field

Coated snack food products and methods for making same are described herein. More specifically, a method for delivering a wide variety of visually appealing snack foods is described herein.

### Description of Related Art

Snack foods such as potato or tortilla chips typically comprise a layer of seasoning particles. For example, tortilla chips are made from yellow and white dent corn materials, which under nixtamilization process and lime cooking to form a dough known as masa. The masa is sheeted and cooked to a shelf-stable snack food product. These and other shelf-stable food products are typically coated in oil and seasoning powders to produce a layer of seasoning particles. There remains a desire for improving upon and/or varying the texture experience provided by such seasoned shelf-stable snack food products.

### SUMMARY

Below is a simplified summary of this disclosure meant to provide a basic understanding of some aspects of the products and methods described herein. This is not an exhaustive overview and is not intended to identify key or critical elements or to delineate the scope of the description. Its sole purpose is to present some concepts in a simplified form as a prelude to the more detailed description below.

The present disclosure provides for a snack food product coated with a coating solution sufficient of providing pick-up levels of up to 85% flavored and unflavored coatings by weight of the snack food product. The high level of coating provides for products with multiple layers of unique textures and appearance.

The method of making a coated food product comprising the steps of dehydrating a farinaceous food base to form an intermediate food product comprising a moisture content greater than 5% and less than about 40% by weight, coating the intermediate food product with a coating mixture comprising a viscosity of between about 100 to about 1,000 cp to form a coated food product, and dehydrating the coated food product to a shelf-stable food product moisture content with a moisture content of less than 5% by weight, the shelf-stable food product comprises multiple layers of different textures.

In an exemplary embodiment, the coating mixture comprises a farinaceous batter or slurry to form a coated food product. In some embodiments, the batter comprises waxy starch. In some embodiments comprising waxy starch, the waxy starch comprises at least one of waxy corn starch, waxy potato starch, waxy barley, and waxy wheat. In some embodiments comprising the wheat-based flours, and waxy potato starch, the battered product is coated with a dry breading. In any embodiment, dehydrating to a shelf-stable moisture content is accomplished by frying.

In a second embodiment, the coating mixture comprises an aqueous glaze comprising water soluble ingredients, for example: soluble fibers or corn syrups.

In a third embodiment, the coating mixture comprises a corn syrup to form the coated food product, followed by the step of applying a dry flour or breading to the coated food product and frying to form a breaded product.

In a fourth embodiment, the coating mixture comprises a protein-based formulation. In some embodiments, the protein-based formulation comprises egg whites.

In an exemplary embodiment, the method of making a coated food product produces a food product comprising a farinaceous base layer comprising waxy starch of at least 2% by weight; a coating around the base layer; a moisture content of less than 5%, the base layer and the coating comprising different textures.

Other aspects, embodiments and features of the invention will become apparent in the following written detailed description and accompanying drawings.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 depicts one exemplary embodiment of a method for making coated snack food products as described herein.

FIG. 2 depicts a viscosity curve for a coating mixture according to a first exemplary embodiment.

FIG. 3 depicts a viscosity curve for a coating mixture according to a second exemplary embodiment.

FIG. 4 depicts a viscosity curve for a coating mixture according to a third exemplary embodiment.

FIG. 5 depicts a viscosity curve for a coating mixture according to a fourth exemplary embodiment.

FIG. 6 is a flowchart of one exemplary embodiment of a method of making a battered, shelf-stable snack food product.

### DETAILED DESCRIPTION

The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition is expressly set forth in the specification in a definitional manner that directly and unequivocally provides the special definition for the term or phrase.

The terms “including,” “comprising,” “having,” and variations thereof mean “including but not limited to,” unless expressly specified otherwise. When used in the appended claims, in original and amended form, the term “comprising” is intended to be inclusive or open-ended and does not exclude any additional, unrecited element, method, step or material. The term “consisting of” excludes any element, step or material other than those specified in the claim. The term “consisting essentially of” limits the scope of a claim to the specified elements, steps or material(s) and those that do not materially affect the basic and novel characteristic(s) of the claimed invention. As used herein, “up to” includes zero, meaning no amount is added in some embodiments.

Several embodiments for snack foods described herein and methods for making same will now be described with reference to the figures. Unless otherwise noted, like elements will be identified by identical numbers throughout all figures.

One of the snack foods described herein is a shelf-stable multi-layered food product. The food product comprises a farinaceous base layer made from at 2% waxy starch by weight, and a coating around the base layer. The food product has a moisture content of less than 5% by weight and the base layer and coating have different textures, thereby providing a multi-layered food product. The food product becomes shelf-stable during the dehydration process discussed below.

In one exemplary embodiment, the food product comprises a farinaceous food base layer. In one embodiment, the food base layer comprises a waxy starch, and in another embodiment, the food base layer comprises corn masa. In further embodiments, the waxy starch comprises waxy corn starch, waxy potato starch, waxy barley starch, and/or waxy wheat starch.

In one exemplary embodiment, the food product comprises a coating surrounding the food base material. In some embodiments, the coating comprises a farinaceous formulation. In some embodiments, the coating comprises a batter made from a waxy starch and the coated food product is a battered food product. In another embodiment, the coating mixture comprises soluble fiber and corn syrup. In another embodiment, the coating mixture comprises a protein-based formulation made from egg whites. In some embodiments, breading is added as a second coating on top of the coating mixture.

As mentioned previously, once the food product is coated, it is then dehydrated to reach a certain moisture content. The dehydration process makes the food product shelf-stable and also creates the layers of different textures for the food product.

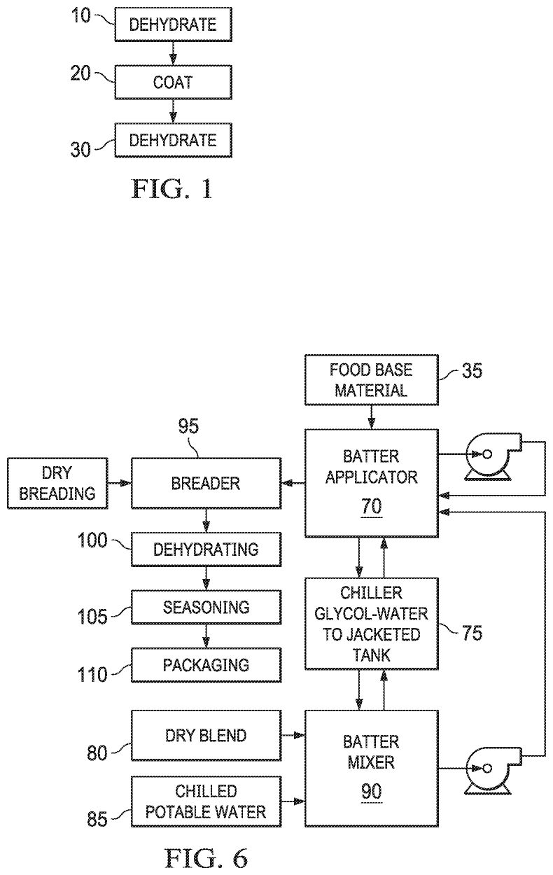

An exemplary method of making a shelf-stable multi-layered food product will now be discussed in reference to FIG. 1. Generally, a food base material is dehydrated (step 10) to a moisture content between about 5% by weight to about 40% by weight to form an intermediate food product, the intermediate food product is coated with a coating mixture (step 20), the coating mixture comprising a viscosity between about 200 to about 1,000 cp; and the coated food product is dehydrated (step 30) to a moisture content of less than about 5% by weight. In some embodiments, the coating mixture comprises a viscosity between about 300 to about 800 cp. In some embodiments, the coating mixture comprises a viscosity between about 400 to about 600 cp.

### The Food Base Material

In an exemplary embodiment, the food base material is farinaceous. In some embodiments, the food base material comprises corn masa, and the coating mixture comprises a batter, such that a battered shelf-stable multi-layered food product is achieved following the method of FIG. 1. In some embodiments, the food base material comprises corn masa and the coating mixture comprises a coating solution that produces a battered/glazed food product following dehydrating to below about 5% moisture content.

In some embodiments, normal yellow dent corn is cooked and soaked in combination with yellow or white waxy corn to form a corn masa. After cooking and soaking, the corn masa is washed, milled and sheeted before dehydrated to form the food base material

In some embodiments, the food base material comprises waxy starch in an amount up to 40% by weight. In some embodiments, the waxy starch amount range from 2% to 40% by weight, and is incorporated into the food base material during formation of the masa. Generally, the addition of waxy starch is performed prior to sheeting the masa. In some embodiments, prior to soaking the corn in forming a masa, the total corn comprises up to about 40% waxy corn type by weight, which is cooked, then soaked and washed prior to milling the corn into masa. In certain embodiments, the waxy starch is added during the milling step. In some embodiments, the waxy starch comprises waxy corn starch, waxy potato starch, waxy wheat starches or waxy barley starch. In some embodiments, the waxy starch comprises about 95-99% amylopectin by weight and 1-5% amylose by weight.

Thus, in some embodiments, in the formation of the intermediate food product (i.e., a soft food product not fully cooked for consumption), waxy starch is added after the corn masa is milled from cooked and soaked yellow dent corn. In other embodiments, waxy corn kernels mixed with yellow dent corn are cooked and soaked before being milled into masa for formation of the intermediate food product. The addition of waxy starch or waxy corn kernels in the corn masa helps create dense, crisp coated food products after using the method shown in FIG. 1.

While the invention is described generally with reference to coating tortilla chip base products in some embodiments, it should be understood that other embodiments comprising other snack food basis are also within the scope of the method described herein. For example, in some embodiments, the food base material comprises extruded and baked/fried corn puffs, and the formulations mentioned in this document is used with the puffs to form puffs with differentiated layered textures and appearance.

Once the food base material is made, the food base is sheeted and cut into snack size portions for dehydration.

### Dehydrating the Food Base Material

With reference to FIG. 1 and the dehydrating step 10, the food base material is generally dehydrated to a moisture content of between about 55% and about 40% by weight. By dehydrating the food base material to create an intermediate food product with a moisture content of between about 5% and about 40% by weight, the intermediate food product is rigid enough to be coated by a coating mixture. Further, the dehydration acts to cook the food base material to deliver a particular texture/consistency in the second dehydration step (step 30). In some embodiments, the dehydrating step 10 comprises dehydrating the food base material to a moisture content of between about 15% and about 40% by weight. In some embodiments, the dehydrating step 10 comprises dehydrating the food base material to a moisture content of between about 18% and about 35% by weight. In some embodiments, the dehydrating step 10 comprises dehydrating the food base material to a moisture content of between about 19% and about 30% by weight. In some embodiments, the moisture content is greater than 20% and less than about 40% by weight.

In some embodiments, the dehydrating step 10 comprises toasting in an oven in one embodiment. Toasting in an infrared oven is an exemplary process to reduce the moisture content from about 51% by weight in the food base material to the necessary moisture content by weight in a short amount of time. Toasting may comprise temperatures of between about 300 F to about 650 F during time intervals of between about 15 seconds to 60 seconds, in some embodiments.

While the exemplary embodiments are described generally with reference to toasting for dehydrating the food base material, it should be understood that other embodiments comprising other methods for dehydration are also within the scope of the method described herein. For example, the food base product may be extruded to form the intermediate food product with a low-moisture content of between about 15% to 40% by weight.

After dehydrating the food base material into an intermediate food product, the intermediate food product is then coated by at least one of the coated mixtures discussed below.

### The Coating Mixtures

Several embodiments of the coating mixtures will now be described. Generally, coating may be achieved by any means known in the art, including without limitation dipping, spraying, waterfall, panning or any combination thereof. In some embodiments, the coated product is drained after the coating step to release excess coating or batter before frying. By providing a coating to the food base material, the food product after dehydration comprises multiple layers with different textures.

The multi-layered food product produced after dehydrating the coated food base material comprises different ranges of firmness as measured by a TA-XT2. In measuring the firmness of the multi-layered food product, the multi-layered food product is placed on the sage of the TA-TX2, and a probe is lowered to break the multi-layered food product. In some embodiments, the probe comprises a TA-101 Crisp chip/cracker Rig and a ¼ inch rounded end probe. The “Compression” program of the TA-XT2 is used to measure the firmness, which the “Compression” program lowers the probe five (5) mmm and reads the force of the probe once a force greater than 5 g is registered.

In some embodiments, the multi-layered food product comprises a firmness ranging from 400 to 2050 g in force. In some embodiments, the multi-layered food product comprises an average firmness of 1134 g in force. In some embodiments, the multi-layered food product comprises a firmness ranging from 400 to 1240 g in force. In some embodiments, the multi-layered food product comprises an average firmness of about 881 g in force. In some embodiments, the multi-layered food product comprises a firmness ranging from 1020 to 1840 g in force. In some embodiments, the multi-layered food product comprises an average firmness of about 1391 g in force. In some embodiments, the multi-layered food product comprises a firmness ranging from 515 to 2050 g in force. In some embodiments, the multi-layered food product comprises an average firmness of about 1129 g in force.

A. Farinaceous Coating

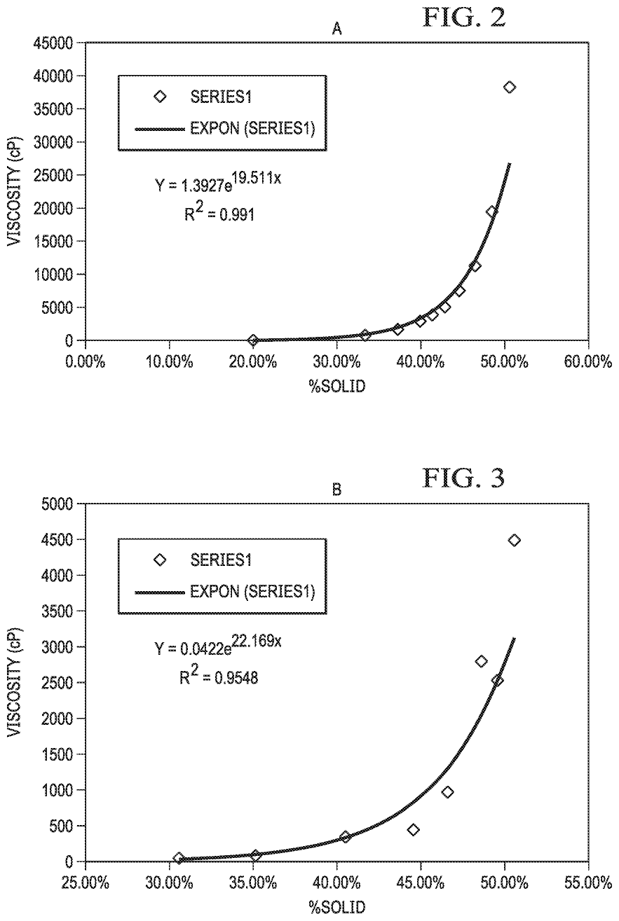

In a first exemplary embodiment, the coating mixture comprises a batter comprising a starch, and the coating step of the method forms a battered food product. For clarity, the first embodiment is referred to in FIG. 2 as a batter, a farinaceous coating, and a farinaceous batter. In some embodiments, the batter comprises at least about 10% waxy starch by weight. In some embodiments, the batter comprises between about 10% to about 80% waxy starch by weight. In some embodiments, the batter comprises between about 20 to about 60% waxy starch by weight. In some embodiments, the batter comprises between about 40 to about 60% waxy starch by weight.

In an exemplary embodiment, the farinaceous batter comprises waxy starches, soft wheat flour, hard wheat flour, tapioca starch, corn flour, corn meal, baking powders, or any combination thereof. Soft wheat flour, hard wheat flour, and corn flours are typical in batter formulations. Waxy and tapioca starches create softer textures/consistencies by increasing amylopectin content in a low moisture food product, such as the intermediate food product produced by dehydrating the base food material. Corn meal reduces pillowing during frying by allowing water vapor to escape the surface of product during frying. In some embodiments, the batter comprises soft wheat flour in an amount ranging between about 5% to about 60% by weight. In some embodiments, the batter comprises soft wheat flour in an amount ranging between about 10% to about 50% by weight. In some embodiments, the batter comprises soft wheat flour in an amount ranging between about 12% to about 40% by weight. In some embodiments, the batter comprises hard wheat flour in an amount ranging between about 5% to about 60% by weight. In some embodiments, the batter comprises hard wheat flour in an amount ranging between about 10% to about 50% by weight. In some embodiments, the batter comprises hard wheat flour in an amount ranging between about 12% to about 40% by weight. In some embodiments, the batter comprises tapioca starch in an amount ranging between about 10% to about 80% by weight. In some embodiments, the batter comprises tapioca starch in an amount ranging between about 20% to about 60% by weight. In some embodiments, the batter comprises tapioca starch in an amount ranging between about 40% to about 60% by weight. In some embodiments, the batter comprises corn flour in an amount ranging between about 5% to about 60% by weight. In some embodiments, the batter comprises corn flour in an amount ranging between about 10% to about 50% by weight. In some embodiments, the batter comprises corn flour in an amount ranging between about 12% to about 40% by weight.

It should be understood that any of the disclosed amounts may be combined so long as the resulting batter has viscosity with a 15%-85% pick-up level by weight so that dehydration to final moisture content can be achieved in reasonable amount of time (1-3 min). In some embodiments, higher viscosity batters (e.g. 40,000 cps) are also used and require a longer time for dehydration to achieve a low moisture snack. Minor amounts of less than about 5% of other components of the farinaceous batter include but are not limited to, for example, salt, xanthan gum, hydroxypropyl methylcellulose (HPMC), baking powder, dextrins, modified starches, native starches, spices (including garlic or garlic powder, granules, or flakes; dried pepper (black, white, cayenne, red), paprika; cumin or any other seasonings known in the art), natural or artificial flavors, natural or artificial colors, monoglycerides, acids (citric, acetic) or any combination thereof.

During test runs, dry components were blended and water was added to form the batter with a viscosity ranging from between about 50 cps to about 40000 cps. Because of the consistency and texture of the batter, the farinaceous batter naturally picks up any material with which it comes in contact. Pickup levels refer to the amounts of coating material that the food base material successfully picks up in relation to the initial weight of the food base material and maintains following the dehydrating to low moisture contents of less than about 5% by weight. For the farinaceous batter described herein, pickup levels ranged from between about 15%-85% by weight, depending on the viscosity of the batter produced and following dehydration step 30. Dehydration time depends on the batter pick up levels and desired product final texture and moisture. In some embodiments, dehydration time ranges from 1 to 10 min at 350-380 F depending on batter viscosity and pick-up. In some embodiments, the farinaceous batter comprises a pickup level of between about 15% to 85% by weight prior to dehydration. In some embodiments, the farinaceous batter comprises between about 20% to about 30% solids to achieve pickup levels ranging from about 200% to about 300% by weight.

FIG. 2 demonstrates the viscosity curve of the farinaceous batter as described for the exemplary embodiment of the coating mixture. The viscosity and solids data of FIG. 2 are shown below in Table 1.

TABLE 1
Viscosity and Solids Data of Coating Mixture

| Water (g) | Dry Mix (g) | % solid | Viscosity (cp) | Temp (F.) |
|---|---|---|---|---|
| 220 | 225 | 50.56 | 38184 | 63 |
| 240 | 225 | 48.39 | 19492 | 64 |
| 260 | 225 | 46.39 | 11366 | 63.7 |
| 280 | 225 | 44.55 | 7459 | 64.1 |
| 300 | 225 | 42.86 | 5150 | 64 |
| 320 | 225 | 41.28 | 3907 | 64 |
| 340 | 225 | 39.82 | 3019 | 64 |
| 380 | 225 | 37.19 | 1776 | 65 |
| 450 | 225 | 33.33 | 888 | 63.8 |
| 900 | 225 | 20.00 | 83.8 | 63 |

In the exemplary embodiments, the pH of the farinaceous batter ranges from 6-7 at 60-70 degrees F. Accordingly, for commercial operations, the batter should be maintained at 35-40 F to prevent undesirable microbial growth. In some embodiments, food acids, like citric or acetic acids, are added to the batter to get the pH to be less than 4.6 so that the batter can be maintained between 60-70 F while also prevent undesirable microbial growth.

B. Coating Mixture with Breading

A second exemplary embodiment of the coating mixture is reflected in the viscosity curve of FIG. 3 This exemplary embodiment allows for the additional step of adding bread crumbs to the food base material to form a breaded, battered shelf-stable snack food product in some embodiments. Generally, this coating mixture comprises a significant amount (i.e., more than about 20% by weight) waxy starch. The coating mixture of this second exemplary embodiment comprises waxy starch in an amount of at least about 10% by weight. In some embodiments, the coating mixture comprises waxy potato starch in an amount ranging from about 10% to about 80% by weight. In some embodiments, the coating mixture comprises waxy starch in an amount ranging from about 20% to about 60% by weight. In some embodiments, the coating mixture comprises waxy starch in an amount ranging from about 40% to about 60% by weight.

In some embodiments, the coating mixture further comprises soft wheat flour, and rice flour. In some embodiments, the coating mixture comprises substantially equal amounts of (or parts) soft wheat flour, corn flour, and rice flour. As used herein, “substantially equal” is meant to refer to near equivalent amounts of these dry components, with a variation of no more than 5% in some embodiments. In other embodiments, the variation comprises a difference of about 3% between the components. In some embodiments, the variation comprises no more than a 1% difference between the cake flour, corn flour, and rice flour. In some embodiments, the batter of the second exemplary embodiment comprises each of the soft wheat flour, corn flour, and rice flour in amounts of between about 30 to about 60% by weight. Minor amounts (less than 5% by weight) of flour salt, baking powder, corn meal, HPMC, monoglycerides, and dextrins may also be present in the batter of the second exemplary embodiment.

In some embodiments, after coating the intermediate food product with the batter as described herein, the method further comprises a step of applying bread crumbs to the battered product. During test runs, panko bread crumbs comprising a particle size of 500 micron were applied and the battered and breaded product was fried at about 340-380 degrees F. for less than about 3 minutes to achieve a pickup level of between about 60%-80% by weight. In some embodiments, the batter of the second exemplary embodiment comprises a viscosity ranging from about 40 cp to about 4500 cp and between about 20% to about 50% solids.

FIG. 3 depicts the solids data and viscosities achieved and successfully applied during test runs, the values for which can be found below in Table 2.

TABLE 2
Viscosity and Solids Data of Coating Mixture “B”

| Water (g) | Dry Mix (g) | % solid | Viscosity (cp) | Temp (F.) |
|---|---|---|---|---|
| 220 | 225 | 50.56 | 4484 | 63 |
| 229 | 225 | 49.56 | 2531 | 64 |
| 238 | 225 | 48.6 | 2797 | 58 |
| 258 | 225 | 46.58 | 976.8 | 60 |
| 280 | 225 | 44.55 | 444 | 60 |
| 330 | 225 | 40.54 | 355.2 | 68 |
| 415 | 225 | 35.16 | 83.8 | 58 |
| 510 | 225 | 30.61 | 52.4 | 69 |
| 720 | 225 | 23.81 | 41.9 | 66 |
| 1050 | 225 | 17.65 | 31.4 | 64 |

C. Corn Syrup Coating Mixture

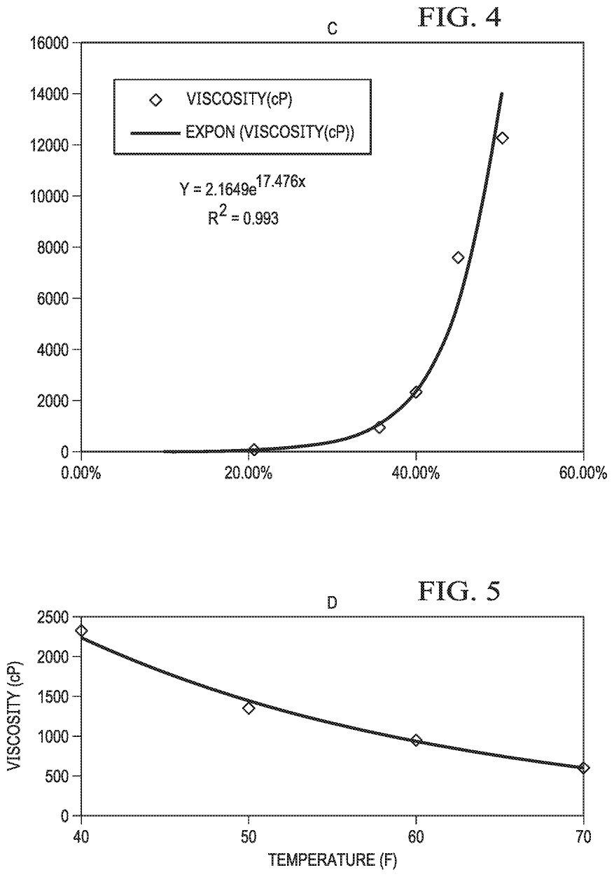

A third exemplary embodiment of the coating mixture is shown in FIG. 4. This coating mixture of the third exemplary embodiment comprises corn syrup solids. In some embodiments, the coating mixtures comprises corn syrup. In some embodiments, the coating mixture consists of a corn syrup and water. Suitable corn syrup solids may be obtained, for example, from Ingredion under the name N-Tack. In some embodiments, the corn syrup solids is derived from waxy corn so a relatively high concentration of waxy corn syrup solution can be made at relatively low viscosities at ambient temperatures. In some embodiments, corn syrup solution is made from regular dent corn. The solids level of the coating mixture may vary in some embodiments, depending upon the desired pickup. In some embodiments, the coating mixture comprising corn syrup may comprise solids ranging from about 2% to about 40% by weight. In some embodiments, the coating mixture comprising corn syrup may comprise solids ranging from about 5 to about 30% by weight. In some embodiments, the coating mixture comprising corn syrup may comprise solids ranging from about 15 to about 25% by weight.

Table 3 below depicts the data used to obtain the viscosity graph of FIG. 4.

TABLE 3
Viscosity and Solids Data of Coating Mixture

| Water (g) | Dry Mix (g) | % solid | Viscosity (cp) | Temp (F.) |
|---|---|---|---|---|
| 220 | 222 | 50.23 | 12254 | 65 |
| 270 | 222 | 45.12 | 7548 | 67 |
| 330 | 222 | 40.22 | 2353 | 65 |
| 400 | 222 | 35.69 | 976.8 | 63 |
| 850 | 222 | 20.71 | 83 | 55 |
| 2000 | 222 | 9.99 | | |

In some embodiments, after coating the intermediate food product in the coating mixture of the third exemplary embodiment, the method comprises the step of dipping the coated food product into a dry flour or breading mix. Generally, the dry breading may comprise all-purpose flour or any other type of cereal based flour combined with minor ingredients including spices (garlic and/or onion powder or granules, peppers, or any other seasonings known in the art), baking powder and salt. In some embodiments, the breading comprises up to about 75% all-purpose flour by weight. In some embodiments, the breading comprises between about 50% to about 100% all-purpose flour by weight. In some embodiments, the breading comprises up to about 30% starch by weight, and in some embodiments, the starch of the breading is derived from corn or potato. In some embodiments, the breading comprises between about 10% to about 20% starch. Additional seasonings and flavors may also be added in an amount of up to about 20%. In some embodiments, the dry mix may further comprise baking powder in an amount of up to about 5%.

D. Fiber-Based Coating Mixture

A fourth exemplary embodiment of the coating mixture is reflected in FIG. 5. The coating mixture of the fourth exemplary embodiment comprises a fiber-based formulation. Such embodiment of the coating mixture comprises soluble fibers. In some embodiments, the fiber is a soluble fiber. In some embodiments, the coating mixture comprises inulin, and in other embodiments, the coating mixture comprises short chain fructo oligosaccharides (sc-FOS) (e.g. Nutraflora from Ingredion or Orafti-P95 from Beneo). In some embodiments, the coating mixture comprises inulin/sc-FOS and a corn syrup comprising a sugar content of about 15%. In some embodiments, the coating mixture comprises inulin/sc-FOS, the corn syrup, and a polydextrose (i.e., Tate & Lyle STA-LITE). In some embodiments, the coating mixture comprises a combination of inulin/sc-FOS, the corn syrup and the polydextrose in an amount of up to about 75% by weight. In certain embodiments, each of the inulin/sc-FOS, the corn syrup, and the polydextrose are present in substantially equal amounts of up to about 25% by weight. In some embodiments, the coating syrup consists of the inulin/sc-FOS, the corn syrup, the polydextrose and water. In some embodiments, the coating mixture comprises between about 10 to about 75% inulin/sc-FOS by weight. In some embodiments, the coating mixture comprises between about 15 to about 35% inulin/sc-FOS by weight. In some embodiments, the coating mixture comprises between about 10 to about 75% corn syrup by weight, the corn syrup comprising the sugar content of about 15% by weight. In some embodiments, the coating mixture comprises between about 15 to about 35% corn syrup by weight. Some embodiments of the coating mixture comprise between about 10% to about 50% polydextrose by weight. Some embodiments of the coating mixture comprise between about 15% to about 35% polydextrose by weight. In some embodiments, a coating mixture comprising soluble fiber comprises a viscosity of between about 400 to about 800 cp at 60 degrees F. In some embodiments, a coating mixture comprising fiber comprises a viscosity of between about 500 to about 700 cp at 60 degrees F. In some embodiments, the coating mixture comprising the fiber, as described herein, comprises a viscosity of about 600 cp at 60 degrees F. At the viscosities discussed, the fiber-based formulation is able to produce pickup levels of between about 15%-55% by weight when combined with a food base material or an intermediate food product as described below, and dehydrated at temperatures of about 340-380 degrees F. for less than 3 minutes.

The coating mixture of the fourth exemplary embodiment, when applied to the intermediate food product and then dehydrated to achieve a moisture content of less than 5% by weight, results in a coated/glazed food product that has 16% fat by weight after dehydration. The glazed surface on the food product prevents normal levels of fat absorption typically seen (about 25% by weight) in standard tortilla chips with no glazing. Thus application of the coating mixture of the fourth exemplary embodiment results in shelf-stable multi-layered food products that are at least 25% reduced fat by weight than standard tortilla chips.

In some embodiments, the food base material comprises between about 49-52% moisture by weight, 2-40% waxy starch by weight, and 0.5-2% monoglycerides by weight. In some embodiments, the food base material comprises dry corn solids derived from the corn used in cooking & soaking process. In some embodiments, the food base material comprises monoglycerides. In some embodiments, the food base material comprises monoglycerides, diglycerides, lecithin, hydrolyzed lecithin, or other emulsifiers that are capable of complexing with starch to deliver a softer texture in the shelf-stable multi-layered food product. Embodiments wherein the coating mixture comprises inulin/sc-FOS and other ingredients mentioned above may subjected to frying steps without any intervening steps or additional topical components such as breading. Coating steps for such embodiments may be performed, for example, at temperatures of about 35-140 F. FIG. 5 depicts suitable viscosities for the coating mixture of the fourth exemplary embodiment. For example, depending on the temperature the coating mixture comprises a viscosity ranging from about 150-800 cp. In any embodiment described herein, the food base material may also comprise spices or other flavoring ingredients.

E. Protein-Based Coating Mixture

A fifth embodiment of the method described herein may comprise the step of coating the food base material with a protein-based formulation comprising egg whites. In some embodiments, a formulation comprising egg whites also comprises up to about 2% cream of tartar whipped with the egg white until stiff peaks form. Up to 40% cake flour (by weight of the coating mixture) is then sifted into the foamy composition slowly, while also adding up to 2% table salt (i.e., sodium chloride) by weight, and additional minor amounts (<5% by weight) seasonings including without limitation onion powder, garlic powder, black pepper, red pepper, yellow pepper, and/or any other seasonings known in the art. Once the protein-based coating mixture is made, the food base material is coated in the coating mixture to form an even coating prior to dehydration. During test runs, a masa dough comprising a moisture content of about 51% by weight was cooked and dehydrated to about 25% moisture by weight and then was coated in the protein-based coating mixture. Dehydration was subsequently performed at about 375 F for about 4 minutes, using a free frying process for about 20 seconds, followed by submerged frying for the remaining frying time. Following dehydration, the dehydrated, coated product was dried in a convection oven for about 30 minutes at about 260 F to reduce the moisture content of the food product to less than 5% by weight. This egg-white based coated shelf-stable multi-layered food product comprises a unique soft & crumbly texture and consistency due to the foamy nature of the egg white based coating applied on the dehydrated chip before dehydration.

With reference back to FIG. 1, following the dehydrating step 10, and the coating step 20, an additional dehydrating step 30 is performed to reduce the moisture content of the coated and/or breaded food product to a shelf-stable moisture content of less than about 5% by weight. In some embodiments, the moisture is reduced to less than about 4% by weight. In some embodiments, the moisture is reduced to less than about 3% by weight. The dehydrating step 30 may comprise any of: frying, deep-frying, free-frying, submerged frying, baking, toasting or any combination thereof. In some embodiments, the dehydrating step 30 comprises deep-frying.

When applying any of the coating mixtures described above to dehydrated intermediate food bases comprising corn, the above methods provide for compensating for the suppression of blister formation during frying, and still producing significantly less dense but crunchy texture experience without the blisters that are typical in tortilla chips.

Formed coated snack food products comprise an outer edible coating on at least a portion of a food base, the food base comprising a texture unlike that of the outer edible coating, thus producing a unique dual-textured eating experience.

The methods described herein may be performed on a batch or continuous basis. Thus, in one embodiment, the method described is a continuous process, meaning a process that operates with a substantially or entirely uninterrupted flow of materials into and/or resulting from the process. In one embodiment, a continuous process is one that creates a throughput of at least about 250 lbs/hour. In one embodiment, a continuous process is one that creates a throughput of about 500 lbs/hour. In one embodiment, a continuous process may also include one or more steps performed manually or by other batch-wise means.

The following example, with reference to FIG. 6, demonstrates one embodiment of practicing the invention described above in a continuous process. A food base material 35 is put through a batter applicator 70. The batter applicator interacts with a chiller 75 to ensure that the batter applied to the low moisture substrate is maintained at certain temperatures. Batter temperature depends on the pH of batter and pick-up or viscosity desired. For batters with pH>4.6, batter temperatures are maintained at <50 F. Coating temperatures are generally maintained around 55-80 F. In general, batter temperatures vary from 35-45 F depending on batter pH and viscosity/pick-up desired. Simultaneous with the preparation of a food base material, the dry blend 80 is added together with water 85 comprising a temperature of about 40-70 F into a batter mixer 90. Following application of a batter 70, battered product may be subjected to a breading step 95, followed by dehydrating 100, seasoning 105 and packaging 110. In some embodiments, dehydrating comprises frying at between about 350 F to about 380 F.

Unless otherwise specified, all percentages, parts and ratios as used herein refer to percentage, part, or ratio by weight of the total. Unless specifically set forth herein, the terms “a”, “an”, and “the” are not limited to one of such elements, but instead mean “at least one,” unless otherwise specified. The term “about” as used herein refers to the precise values as indicated as well as to values that are within statistical variations or measuring inaccuracies.

The methods disclosed herein may be suitably practiced in the absence of any element, limitation, or step that is not specifically disclosed herein. Similarly, specific snack food embodiments described herein may be obtained in the absence of any component not specifically described herein. Thus, the coating mixtures and/or food materials described herein may consist of those listed components as described above.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. For example, the range 1 to 10 also incorporates reference to all rational numbers within that range (i.e., 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7) and, therefore, all sub-ranges of all ranges expressly disclosed herein are hereby expressly disclosed. These are only examples of what is specifically intended and all possible combinations of numerical values between the lowest value and the highest value enumerated are to be considered to be expressly stated in this application in a similar manner.

While this invention has been particularly shown and described with reference to several embodiments, it will be understood by those skilled in the art that various changes in form and detail may be made therein without departing from the spirit and scope of the invention. The inventors expect skilled artisans to employ such variations as appropriate, and the inventors intend the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

We claim:

1. A method of preparing a food product comprising the steps of:
dehydrating a farinaceous food base material to form an intermediate food product comprising a moisture content between about 5% and about 40% by weight;
coating the intermediate food product with a coating mixture to form a coated food product comprising at least two layers; and
dehydrating the coated food product to form a shelf-stable multi-layered food product comprising a moisture content of less than about 5% by weight, wherein the food product comprises layers of different textures.

2. The method of claim 1 wherein the food base material comprises at least one of waxy starch and corn masa.

3. The method of claim 2, wherein the waxy starch comprises at least one of waxy corn starch, waxy potato starch, waxy barley, and wheat.

4. The method of claim 1, wherein the coating mixture is farinaceous.

5. The method of claim 1 wherein the coating mixture comprises a batter comprising waxy starch, and wherein the coated food product is a battered food product.

6. The method of claim 1 wherein the coating mixture comprises soluble fiber and corn syrup.

7. The method of claim 1, further comprising coating the coated food product with a breading to form a breaded product prior to dehydrating the coated food product.

8. The method of claim 1 wherein the coating mixture is retained on the shelf-stable food product in a dehydrated form, and wherein the coating mixtures results in a reflective surface on the dehydrated coated food product.

9. The method of claim 1 wherein the shelf-stable food product comprises a pick-up level of said coating mixture in an amount between about 100% and 600% by weight of the shelf-stable food product.

10. The method of claim 7, wherein the breading comprises panko crumbs.

11. The method of claim 1 wherein the coating mixture comprises a viscosity of between about 200 to about 1,000 cp.

12. The method of claim 1 wherein the coating mixture comprises egg whites.

13. A product of the method of claim 1.

14. A food product comprising:
a farinaceous base layer comprising waxy starch of at least 2% by weight;
a coating around the base layer;
a moisture content of less than 5%;
wherein the base layer and the coating comprises different textures.

15. The food product of claim 14, wherein the coating comprises a waxy starch.

16. The food product of claim 14, wherein the waxy starch of the base layer comprises at least one of waxy corn starch, waxy potato starch, waxy barley, and wheat.

17. The food product of claim 14, wherein the coating comprises soluble fiber and corn syrup.

18. The food product of claim 14, wherein the coating comprises egg whites.

19. The food product of claim 14, further comprising a second coating on top of the coating, wherein the second coating comprises breading.

20. The food product of claim 14, wherein the food base material comprises corn masa.
